(19) United States
(12) Patent Application Publication
(10) Pub. No.: US 2014/0325059 A1
(43) Pub. Date: Oct. 30, 2014

(54) MONITORING DEVICE, COMPUTING DEVICE, CLIENT MONITORING METHOD, AND HOST MONITORING METHOD

(71) Applicant: HON HAI PRECISION INDUSTRY CO., LTD., New Taipei (TW)

(72) Inventors: JUI-LUNG LIN, New Taipei (TW); ZHEN-HONG WU, New Taipei (TW); KUO-YUAN CHANG, New Taipei (TW)

(73) Assignee: HON HAI PRECISION INDUSTRY CO., LTD., New Taipei (TW)

(21) Appl. No.: 14/259,260

(22) Filed: Apr. 23, 2014

(30) Foreign Application Priority Data
Apr. 24, 2013 (TW) 102114566

(51) Int. Cl. H04L 12/26

(52) U.S. Cl. CPC H04L 43/04
USPC 709/224

(57) ABSTRACT

A monitored scene is monitored between an electronic device and a computing device. The electronic device generates monitoring data of the monitored scene and sends the monitoring data of the monitored scene to the computing device. The computing device notifies a user of a selected user ID to check the monitoring data.

### FIELD

Embodiments of the present disclosure relate to monitoring technology, and particularly to a monitoring device, a computing device, a client monitoring method and a host monitoring method.

### BACKGROUND

A typical monitoring system includes a plurality of monitoring devices (e.g., surveillance cameras). However, most monitoring devices are installed in a fixed place, and each monitoring device is restricted to monitor a fixed area. Therefore, there is room for improvement in the art.

### BRIEF DESCRIPTION OF THE DRAWINGS

FIG. 1 is a block diagram of one embodiment of a computing device connected to a monitor device, and an electronic device.

FIG. 2 is a block diagram of one embodiment of a client monitoring system in the monitoring device in FIG. 1.

FIG. 3 is a block diagram of one embodiment of a host monitoring system in the computing device in FIG. 1.

FIG. 4 is a flowchart illustrating one embodiment of a client monitoring method.

FIG. 5 is a flowchart illustrating one embodiment of a host monitoring method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

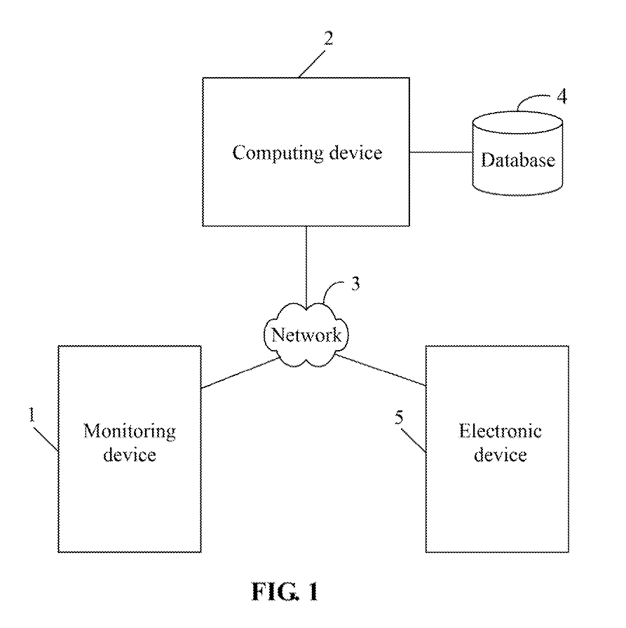

FIG. 1 is a block diagram of one embodiment of a computing device 2 connected to a monitoring device 1, and an electronic device 5. Depending on the embodiment, the computing device 2 is wirelessly connected to the monitoring device 1 and the electronic device 5 via a network 3 (e.g., the Internet or a local area network), as shown in FIG. 1.

The monitoring device 1 generates monitoring data for a scene to be monitored (hereinafter “monitored scene”), and sends the monitoring data to the computing device 2. The monitoring data may be, but is not limited to, pictures, videos, location information, user information (e.g., a name of a user or a badge number of the user), a time, and an introduction of a monitored scene. In addition, the monitoring device 1 may encrypt the monitoring data for information security.

The computing device 2 is connected to a database 4. The database 4 stores the monitoring data from the monitoring device 1. The database 4 further stores a user identification (ID) list. The user ID list includes one or more user IDs. Each user ID includes a password, a username, an e-mail address, a telephone number or other information. The database 4 stores one or more monitoring event. Each monitoring event is assigned to a storage space (e.g., four gigabytes) of the database 4. In other words, four gigabytes is assigned to the generated monitoring event when the monitoring event is generated in the database 4. Each monitoring event is a table which includes an organized set of data elements using a model of vertical columns and horizontal rows. Each monitoring event may include a specified number of vertical columns, and include any number of horizontal rows. Each monitoring event includes one or more user IDs, the monitoring data, and a status of each user ID stored in the monitoring event. The status of each user ID includes a first status and a second status. The first status indicates that a user of the user ID does not check the monitoring data. The second status indicates that the user of the user ID has checked the monitoring data. The status of each user ID is originally preset to be the first status as a default.

The monitoring device 1 may be, but is not limited to, mobile phones, tablet computers, personal digital assistants (PDAs), or any other portable electronic devices. In other words, the monitoring device 1 is not installed at a fixed place. The computing device 2 may be, but is not limited to, a computer, a server, a portable electronic device, or any other electronic device.

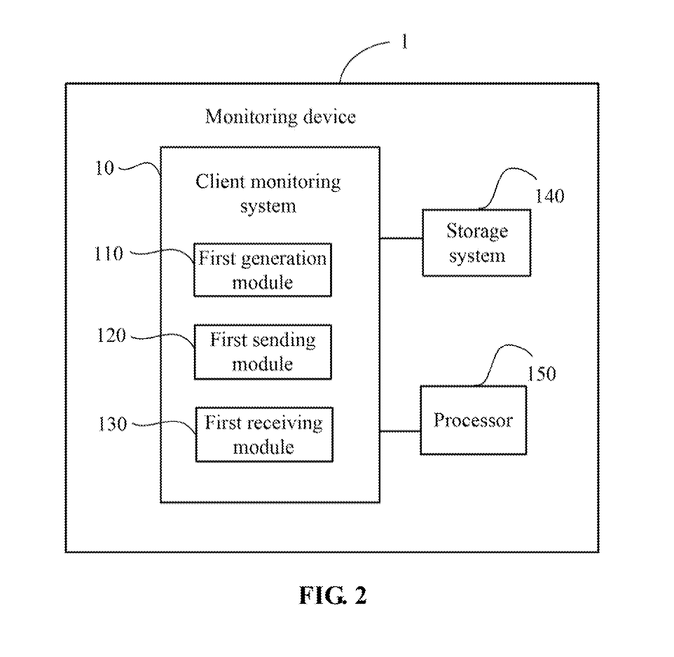

FIG. 2 is a block diagram of one embodiment of a client monitoring system 10 in the monitoring device 1 in FIG. 1. In one embodiment, the client monitoring system 10 includes a first generation module 110, a first sending module 120, and a first receiving module 130. The modules 110-130 may include computerized code in the form of one or more programs that are stored in a storage system 140 of the monitoring device 1. The computerized code includes instructions that are executed by the at least one processor 150 of the monitoring device 1 to provide functions for modules 110-130. The storage system 140 may be a memory chip, a hard disk drive, or a flash memory stick.

The first generation module 110 generates the monitoring data of the monitored scene. In one embodiment, the first generation module 110 controls a camera of the monitoring device 1 to take the pictures and videos of the monitored scene. The first generation module 110 activates location service of the monitoring device 1 to obtain location information of the monitored scene. An introduction of the monitored scene is inputted by a keyboard of the monitoring device 1. The first generation module 110 integrates the pictures and videos of the monitored scene, the location information of the monitored scene, and the introduction of the monitored scene into a single file (e.g., a compressed file). The first generation module 110 may also integrates the user information of the user into the file.

The first sending module 120 notifies the computing device 2 to generate a monitoring event in the computing device 2. In one embodiment, the first sending module 120 sends a first command to the computing device 2 and notifies the computing device 2 to generate the monitoring event in the computing device 2.

The first sending module 120 obtains the user ID list from the computing device 2. In one embodiment, the first sending module 120 sends a second command to the computing device 2 and requests the computing device 2 to send the user ID list to the monitoring device 1.

The first receiving module 130 receives the user ID list from the computing device 2 and selects a user ID from the user ID list. In one embodiment, the user ID list is displayed in a screen of the monitoring device 1, the user ID is selected from the user ID list when the user ID is clicked or touched the user ID on the screen.

The first sending module 120 further sends the selected user ID and the monitoring data to the computing device 1 and saves the selected user ID and the monitoring data into the generated monitoring event.

The first receiving module 130 receives a notification from the computing device 1 when the monitoring data has been checked by the electronic device 5 which is authorized to the selected user ID.

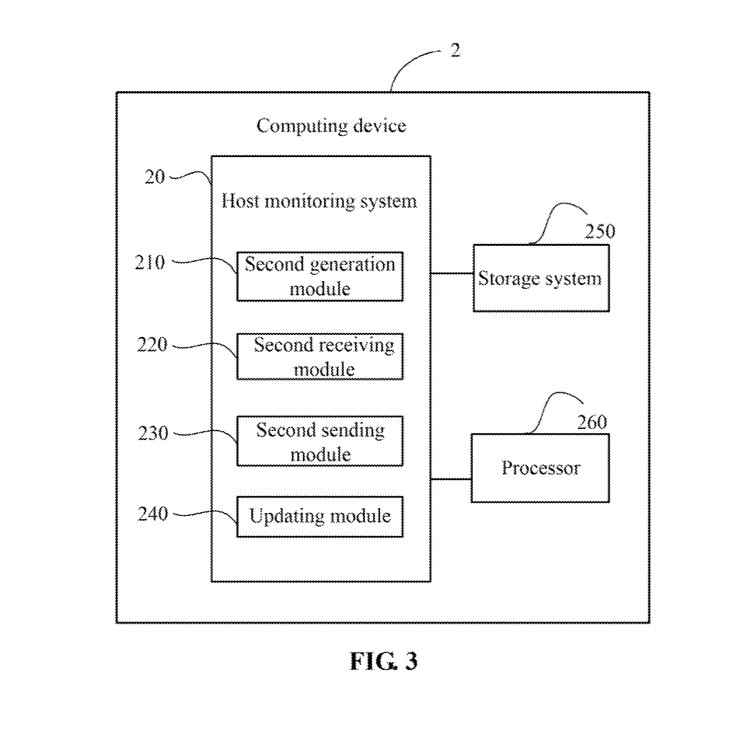

FIG. 3 is a block diagram of one embodiment of a host monitoring system 20 in the computing device 2 in FIG. 1. In one embodiment, the host monitoring system 20 includes a second generation module 210, a second receiving module 220, a second sending module 230, and an updating module 240. The modules 210-240 may include computerized code in the form of one or more programs that are stored in a storage system 250 of the computing device 2. The computerized code includes instructions that are executed by the at least one processor 260 of the computing device 2 to provide functions for modules 210-240. The storage system 250 may be a memory chip, a hard disk drive, or a flash memory stick. Additionally, the storage system 250 stores the user ID list, the monitoring data and the monitoring event as an option for replacing the database 4. In such a situation, the database 4 can be omitted.

The second generation module 210 generates the monitoring event. In one embodiment, the second generation module 210 receives the first command from the monitoring device 1 and generates the monitoring event corresponding to the monitoring device 1.

The second receiving module 120 receives the second command from the monitoring device 1 and sends the user ID list to the monitoring device 1. In one embodiment, the second command includes an Internet protocol (IP) address of the monitoring device 1. The second receiving module 120 sends the user ID list to the monitoring device 1 according to the IP address of the monitoring device 1.

The second receiving module 120 further receives the monitoring data and the selected user ID from the monitoring device 1 and saves the monitoring data and the selected user ID into the monitoring event.

The second sending module 230 notifies the electronic device 5 which is authorized to the selected user ID to check the monitoring data. In one embodiment, the second sending module 230 sends a push (e.g., a short message or an e-mail) to the electronic device 5 which is authorized to the selected user ID. The push may be, but is not limited to, a link. The monitoring data is checked by clicking the link displayed on a screen of the electronic device 5.

The updating module 240 updates the status of the selected user ID from the first status to the second status in the monitoring event when the monitoring data has been checked by the electronic device 5 which is authorized to the selected user ID.

The second sending module 230 further sends the notification to the monitoring device 1 when the monitoring data has been checked by the electronic device 5 which is authorized to the selected user ID.

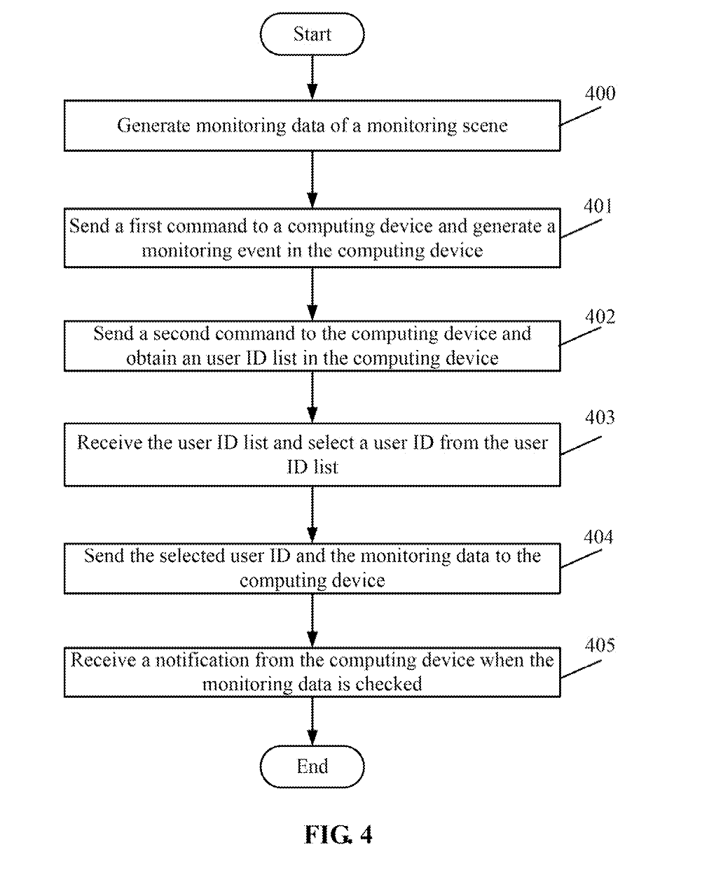

FIG. 4 is a flowchart illustrating one embodiment of a client monitoring method. Depending on the embodiment, additional steps can be added, other steps can be deleted, and the ordering of the steps can be changed.

In 400, the first generation module generates the monitoring data of the monitored scene. In one embodiment, the first generation module compresses the pictures, the videos, the location information, the user information, and the introduction of the monitored scene into the single file. The single file is regarded as the monitoring data.

In 401, the first sending module sends the first command to the computing device, and notifies the computing device to generate the monitoring event in the computing device.

In 402, the first sending module sends the second command to the computing device, and requests the computing device to send the user ID list to the monitoring device.

In 403, the first receiving module receives the user ID list from the computing device and selects the user ID from the user ID list. As mentioned above, the user ID list is displayed in the screen of the monitoring device, the user ID is selected from the user ID list when the user ID is clicked or touched on the screen.

In 404, the first sending module further sends the selected user ID and the monitoring data to the computing device. In one embodiment, the computing device saves the selected user ID and the monitoring data into the generated monitoring event.

In 405, the first receiving module receives a notification from the computing device when the monitoring data has been checked by the electronic device which is authorized to the selected user ID. The notification includes the username of the selected user ID, a time when the monitoring data is checked, or other information.

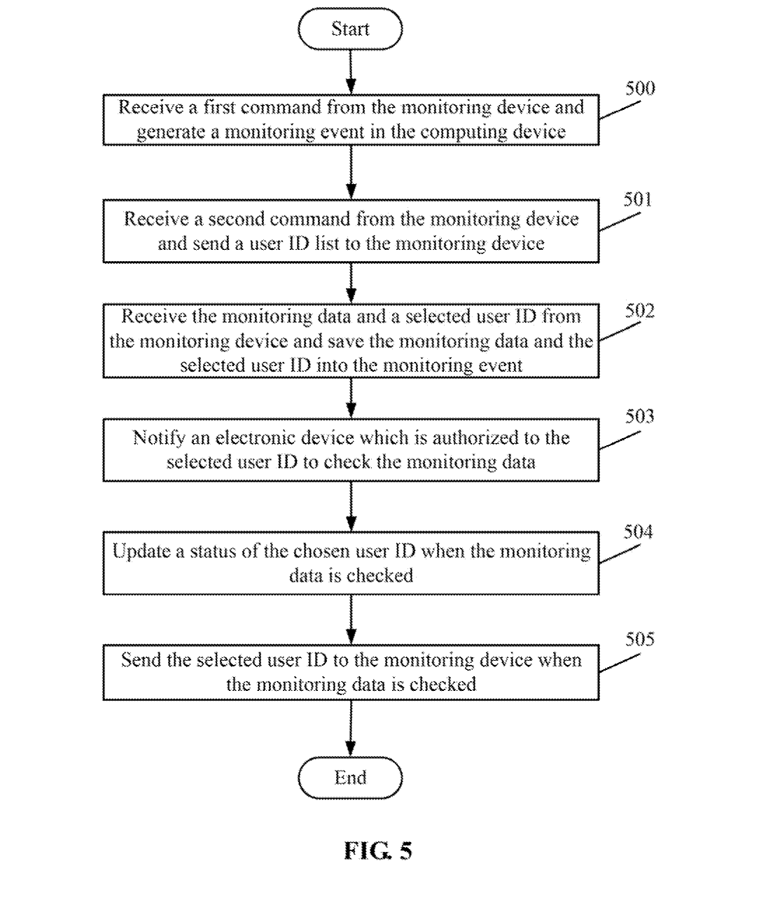

FIG. 5 is a flowchart illustrating one embodiment of a host monitoring method. Depending on the embodiment, additional steps can be added, other steps can be deleted, and the ordering of the steps can be changed.

In 500, the second generation module generates the monitoring event when the second generation module receives the first command from the monitoring device.

In 501, the second receiving module receives the second command from the monitoring device and sends the user ID list to the monitoring device.

In 502, the second receiving module further receives the monitoring data and the selected user ID from the monitoring device and saves the monitoring data and the selected user ID into the monitoring event.

In 503, the second sending module notifies the electronic device which is authorized to the selected user ID to check the monitoring data.

In 504, the updating module updates the status of the selected user ID from the first status to the second status in the monitoring event when the electronic device which is authorized to the selected user ID has checked the monitoring data.

In 505, the second sending module further sends the notification to the monitoring device when the electronic device which is authorized to the selected user ID has checked the monitoring data.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A monitoring device in communication with a computing device connected to an electronic device, the monitoring device comprising:
at least one processor; and
a storage system that stores one or more programs, which when executed by the at least one processor, cause the at least one processor to:
generate monitoring data of a monitored scene;
notify the computing device to generate an monitoring event corresponding to the monitoring device;
receive a user ID list from the computing device and select a user ID from the user ID list;
send the selected user ID and the monitoring data to the computing device and store the selected user ID and the monitoring data into the monitoring event, wherein the computing device sends the monitoring data to the electronic device, and the electronic device is authorized to the selected to the user ID; and
receive a notification from the computing device when the monitoring data is checked by the electronic device which is authorized to the selected user ID.

2. The monitoring device of claim 1, wherein the user ID list comprises one or more user IDs, and each user ID comprises a password, a username, an e-mail address, and a telephone number.

3. The monitoring device of claim 1, wherein the monitoring data comprises pictures, videos, location information, user information, a time and an introduction of the monitored scene.

4. A computing device in communication with a monitoring device and an electronic device, the computing device comprising:
at least one processor; and
a storage system that stores one or more programs, which when executed by the at least one processor, cause the at least one processor to:
generate a monitoring event corresponding to the monitoring device;
send a user ID list to the monitoring device, the monitoring device selecting a user ID from the user ID list;
receive monitoring data and the selected user ID from the monitoring device and save the monitoring data and the selected user ID into the monitoring event;
notify the electronic device which is authorized to the selected user ID to check the monitoring data according; and
update a status of the selected user ID in the monitoring event when the monitoring data is checked by the electronic device which is authorized to the selected user ID.

5. The computing device of claim 4, wherein the monitoring event is a table which comprises an organized set of data elements using a model of vertical columns and horizontal rows.

6. The computing device of claim 4, wherein the status of the selected user ID comprises a first status and a second status.

7. The computing device of claim 6, wherein the first status indicates that the user of the selected user ID does not check the monitoring data.

8. The computing device of claim 6, wherein the second status indicates that the user of the selected user ID has checked the monitoring data.

9. A computer-based client monitoring method using a monitoring device in communication with a computing device connected to an electronic device, the client monitoring method comprising:
generating monitoring data of a monitored scene;
notifying the computing device to generate an monitoring event corresponding to the monitoring device;
receiving a user ID list from the computing device and selecting a user ID from the user ID list;
sending the selected user ID and the monitoring data to the computing device and storing the selected user ID and the monitoring data into the monitoring event, the computing device sending the monitoring data to the electronic device which is authorized to the selected to the user ID; and
receiving a notification from the computing device when the monitoring data is checked by the electronic device which is authorized to the selected user ID.

10. The client monitoring method of claim 9, wherein the user ID list comprises one or more user IDs, and each user ID comprises a password, a username, an e-mail address, and a telephone number.

11. The client monitoring method of claim 9, wherein the monitoring data comprises pictures, videos, location information, user information, a time and an introduction of the monitored scene.

12. A computer-based host monitoring method using a computing device in communication with a monitoring device and an electronic device, the method comprising:
generating a monitoring event corresponding to the monitoring device;
sending a user ID list to the monitoring device, the monitoring device selecting a user ID from the user ID list;
receiving monitoring data and the selected user ID from the monitoring device and saving the monitoring data and the selected user ID into the monitoring event;
notifying the electronic device which is authorized to the selected user ID to check the monitoring data according; and
updating a status of the selected user ID in the monitoring event when the monitoring data is checked by the electronic device which is authorized to the selected user ID.

13. The host monitoring method of claim 12, wherein the monitoring event is a table which is an organized set of data elements using a model of vertical columns and horizontal rows.

14. The host monitoring method of claim 12, wherein the status of the selected user ID comprises a first status and a second status.

15. The host monitoring method of claim 14, wherein the first status indicates that the user of the selected user ID does not check the monitoring data.

16. The host monitoring method of claim 14, wherein the second status indicates that the user of the selected user ID has checked the monitoring data.
